(19) United States
(12) Patent Application Publication
(10) Pub. No.: US 2017/0135885 A1
(43) Pub. Date: May 18, 2017

(54) AIR CELL, AIR MATTRESS AND AIR MATTRESS SYSTEM

(71) Applicant: CARILEX MEDICAL, INC., Guishan Township (TW)

(72) Inventor: Suzanne WANG, Guishan Township (TW)

(21) Appl. No.: 15/345,426

(22) Filed: Nov. 7, 2016

(30) Foreign Application Priority Data
Nov. 18, 2015 (TW) 104138030
Oct. 13, 2016 (TW) 105133046

(51) Int. Cl. A61G 7/057; A47C 27/10; A47C 27/08

(52) U.S. Cl. CPC A61G 7/05776; A47C 27/082; A47C 27/083; A47C 27/10

(57) ABSTRACT

An air cell including a strip body and a waterproof air-permeable cover is provided. The strip body has an air hole, a upper surface, and a side surface integrated with the upper surface. The upper surface is constituted by a air-permeable region and a airproof region. The side surface and the airproof region are made of airproof material, and the air-permeable region is constituted by a opening. The waterproof air-permeable cover is disposed at the strip body and covers the opening. When the air cell is in a use state due to air inflation through the air hole, part of gas in the strip body flows out of the air cell through the waterproof air-permeable cover. In addition, an air mattress and an air mattress system including the air cell is also provided.

### CROSS REFERENCE TO RELATED APPLICATIONS

This application is based on and claims the benefit of priority from Taiwanese Patent Application No. 104138030 filed on Nov. 18, 2015 and Taiwanese Patent Application No. 105133046 filed on Oct. 13, 2016, which are incorporated herein by reference and assigned to the assignee herein.

### FIELD OF THE INVENTION

The present invention relates to an air cell, and particularly relates to an air mattress and an air mattress system having the air cell.

### DESCRIPTION OF THE PRIOR ART

Being capable of preventing bedsores, air beds are widely used for special patients in therapy, for example, patients with large wounds who are unfit to turn the body. A therapeutic air bed comprises a plurality of air cells arranged side by side, an air pump and a control valve device. Each of the air cells is usually tubular. The air pump and the control valve device operate to inflate and deflate the air cells of an air bed alternately and circularly, and thus the surface of the air bed varies, that is, rises and sinks, dynamically. Therefore, the pressure acting on the skin of a patient who uses the air bed can be relieved alternately such that the incidence rate of bedsores to the patient can be reduced.

However, in the situation under which a patient unfit to turn the body is confined to a conventional air bed for a long duration, even if the air cells are inflated and deflated alternately and circularly, the temperature and humidity between the patient and the air cells which are in the period of contacting the patient will increase because of the air-proofing of materials which the air cells are made from. As a result, the patient is still susceptible to bodily discomfort and even predisposed to bedsores.

U.S. Pat. No. 7,409,735 discloses a dynamic cellular person support surface. In U.S. Pat. No. 7,409,735, a person support surface comprising a multitude of inflatable cells is provided. The cells are inflated and deflated to adjust an interface pressure between the person support surface and a person supported by the surface. Wherein, an inflatable cell has an upper surface portion which is made from an air permeable material to provide the openings through which pressurized air is expelled upwardly for solving bodily discomfort as shown in FIG. 8.

However, the air permeable design of inflatable cell is configured on the overall upper surface and the plurality of inflatable cells are a plurality of short upstanding cylindrical cells. The upstanding cylindrical cell design has small inflated body for providing supporting effects. Besides, in the prior art of U.S. Pat. No. 7,409,735, the overall upper surface be configure with air permeable design, and this causes the gas in the upstanding cylindrical cells deflate or loss rapidly. Seriously, when the upstanding cylindrical cell design combines with overall air permeable upper surface design, the supporting function will reduce obviously and can not provide the supporting stability for patients.

### SUMMARY OF THE INVENTION

The present invention provides an air cell and an air mattress/an air mattress system having the air cell which can reduce the temperature and humidity between the air cell and the patient using the air mattress/ air mattress system such that the patient feels comfortable and the incidence rate of bedsores to the patient can be effectively reduced. In addition, the present invention provides an preferred supporting stability.

The present invention provides an air cell comprising a strip body and a waterproof air-permeable cover. The strip body including an air hole, a upper surface, and a side surface integrated with the upper surface, the upper surface is constituted by a air-permeable region and a airproof region, the side surface and the airproof region is made of airproof material, and the air-permeable region is constituted by a opening. The waterproof air-permeable cover is disposed at the strip body and covers the belt-shaped opening. When the air cell is in a use state due to air inflation through the air hole, part of gas in the strip body flows out of the air cell through the waterproof air-permeable cover. Wherein, environmental moisture is prevented from entering the air cell by the waterproof air-permeable cover. Wherein, the area of the air-permeable region is smaller than the area of the airproof region.

According to an embodiment of the present invention, the opening is a belt-shaped opening, a peripheral part of the waterproof air-permeable cover is disposed inside the strip body via the opening and attached to bottom portion of the airproof region.

According to an embodiment of the present invention, the peripheral part of the waterproof air-permeable cover is sewed to bottom portion of the airproof region such that a sewing trace is formed.

According to an embodiment of the present invention, the air cell further comprises an airproof cover attached to and covering the sewing trace, and a part of the airproof region is disposed between the waterproof air-permeable cover and the airproof cover.

According to an embodiment of the present invention, the airproof cover is disposed at the sewing trace by means of high frequency laminate.

According to an embodiment of the present invention, the airproof region is a supporting portion which surrounds the air-permeable region for providing supporting force.

According to an embodiment of the present invention, the area of the air-permeable region is 5-15% area of the upper surface.

The present invention also provides an air mattress comprising a plurality of the air cells, wherein the air mattress is suitable for communicating with a air pump. Wherein, the air pump is communicated to the air cells and adapted to inflate and the air cells through the air holes. Wherein, each of the air cell further has a long edge and a short edge, and the air cell are combined through the long edge of each air cell.

The present invention also provides an air mattress system comprising a plurality of the air cells and an air pump. The opening of each air cell faces upward. The air pump is communicated to the air cells and adapted to inflate and the air cells.

The following description, the appended claims, and the embodiments of the present invention further illustrate the features and advantages of the present invention.

### BRIEF DESCRIPTION OF THE DRAWINGS

FIG. 1 is a perspective view of an air mattress system according to an embodiment of the present invention.

FIG. 2 is a perspective view of one of the air cells of FIG. 1.

FIG. 3 is a cross-sectional view of the air cell of FIG. 2.

### DETAILED DESCRIPTION OF THE EMBODIMENTS

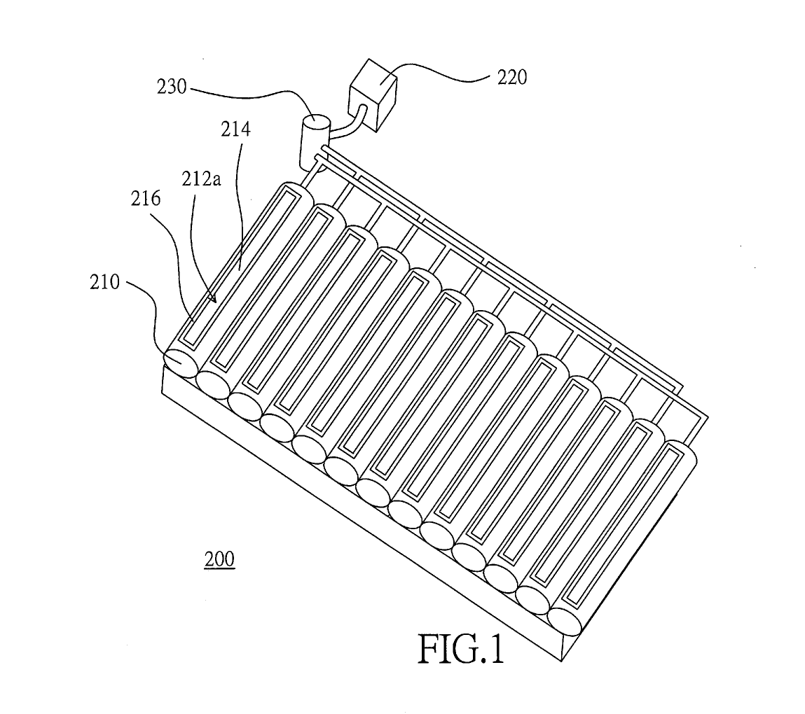

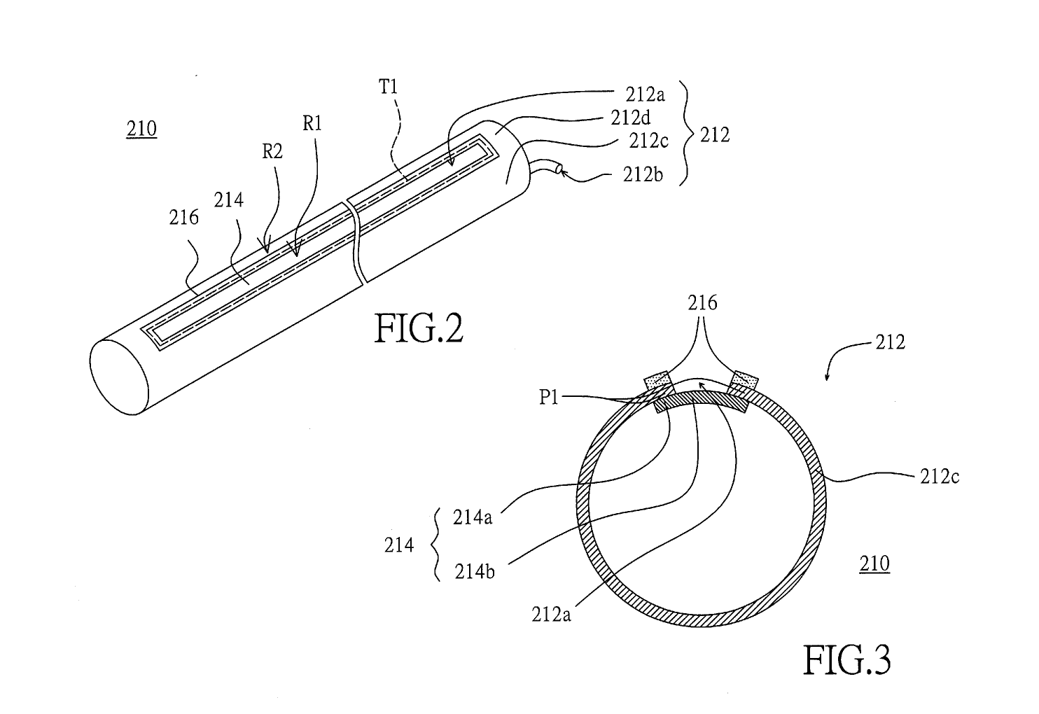

FIG. 1 is a perspective view of an air mattress system according to an embodiment of the present invention. FIG. 2 is a perspective view of one of the air cells of FIG. 1. FIG. 3 is a cross-sectional view of the air cell of FIG. 2. Referring to FIG. 1, in this embodiment, an air mattress system 200 comprises a plurality of air cells 210, an air pump 220 and a control valve device 230. Each of the air cells 210 is usually tubular. The air pump 220 is communicated to the air cells 210 through the control valve device 230 such that each of the air cells 210 is adapted to be inflated and deflated. Wherein, the air cells 210 can be combined to constitute an air mattress. In detail, each of the air cell has a long edge and a short edge, and the air cells 210 are combined through the long edge of each air cell 210.

In this embodiment, the air pump 220 and the control valve device 230 operate to inflate and deflate the air cells 210 of the air mattress system 200 alternately and circularly, and thus the surface of the air mattress system 200 varies, that is, rises and sinks, dynamically. For example, in this embodiment, the air pump 220 and the control valve device 230 operate to inflate the odd-numbered air cells 210 simultaneously but deflate the even-numbered air cells 210 simultaneously and vice versa. In another embodiment, air cells of an air mattress system are inflated and deflated in another predetermined mode, for example, of inflating all the air cells of the air mattress system simultaneously, but the other embodiment is not shown in any figures. However, the present invention is not restricted to the specific ways of inflating and deflating air cells of an air mattress system.

Referring to FIG. 1, FIG. 2 and FIG. 3, each of the air cells 210 comprises a strip body 212 and a waterproof air-permeable cover 214. The strip body 212 has an air hole 212b, a upper surface 212d, and a side surface 212c integrated with the upper surface 212d. The upper surface 212d is constituted by a air-permeable region R1 and a airproof region R2. The side surface 212c and the airproof region R2 is made of airproof material, and the air-permeable region R1 is constituted by a opening 212a. The opening 212a is, for example, a belt-shaped opening. The opening 212a faces upward. The air hole 212b is used to make gas to pass through such that the air cells 210 can be inflated or deflated. The waterproof air-permeable cover 214 is disposed at the strip body 212 and covers the opening 212a. When each of the air cells 210 are inflated via the air hole 212b to thereby be in a use state, part of the gas inside the strip body 212 can be exhausted upwardly from the air cells 210 through the waterproof air-permeable cover 214.

In other words, part of gas in the strip body can flow out of the air cell 210 through the waterproof air-permeable cover 214. In addition, the environmental moisture is prevented from intruding into the air cells 210 by the waterproof air-permeable cover 214. Worth mention, in the embodiment, the area of the air-permeable region R1 is smaller than the area of the airproof region R2. Therefore, part of gas inside the strip body 212 can flow out of the air cell 210 sufficiently for making the patient feel comfortable and prevent form the bedsores effectively. Further, in the embodiment, the airproof region R2 is a supporting portion which surrounds the air-permeable region R1. Based on the design of air-permeable region R1 and airproof region R2 (supporting portion), the air mattress of the embodiment still can provides a efficient supporting force when part of gas inside the strip body 212 flows out of the air cell 210. Wherein, the area of the air-permeable region R1 is 5-15% area of the upper surface 212d. Especially, in a preferred embodiment, the area of the air-permeable region R1 is 9-12% area of the upper surface 212d.

Specifically, in this embodiment, the upper surface 212d of each air cell 210 is, for example, defined as a external surface toward the side provided for person lying when the air cells 210 are combined to constitute the air mattress. Overall, when the air cells 210 are combined to constitute the air mattress, all area of the air-permeable region R1 is 5-15% area of the upper surface of the air mattress provided for person lying.

In this embodiment, a peripheral part 214a of the waterproof air-permeable cover 214 in each air cell 210 is disposed inside the strip body 212 via the opening 212a and attached to bottom portion of the airproof region R2. In other words, the waterproof air-permeable cover 214 is firstly disposed inside the strip body 212 and then attached to the airproof region R2 in a manner of approaching the airproof region R2 such that another part 214b surrounded by the peripheral part 214a is exposed by the opening 212a. In another embodiment, a peripheral part of a waterproof air-permeable cover also can be disposed on the external surface of the strip body and attached to an airproof region R2 (not shown).

In this embodiment, the peripheral part 214a of the waterproof air-permeable cover 214 in each air cell 210 is attached to the airproof region R2 by means of sewing. However, in another embodiment, a peripheral part of a waterproof air-permeable cover in each air cell is attached to an airproof region by means of adhesion.

In this embodiment, the peripheral part 214a of the waterproof air-permeable cover 214 in each air cell 210 is sewed to bottom portion of the airproof region R2 such that a sewing trace T1 is formed. It should be noted, when the peripheral part 214a of the waterproof air-permeable cover 214 is sewed to airproof region R2 through a sewing thread (not shown), a trace formed on the external surface of the airproof region R2 is regarded as the sewing trace T1. To prevent the body fluid of a patient using the air mattress system 200 from seeping into the air cells 210 through the sewing thread and thus protect next patient using the air mattress system 200 against infections, each of air cells 210 in this embodiment further comprises an airproof cover 216 attached to the sewing trace T1 for covering the sewing thread.

Referring to FIG. 3, in each of the air cells 210 of this embodiment, a part P1, to which the peripheral part 214a of the waterproof air-permeable cover 214 is attached, of the airproof region R2 is disposed between the waterproof air-permeable cover 214 and the airproof cover 216. Furthermore, the airproof cover 216 in this embodiment is disposed at the sewing trace T1 by means of high frequency laminate.

In the foregoing embodiment as shown in FIG. 3, the airproof cover 216 is directly attached on the upper surface 212d for covering the sewing trace T1. In another embodiment, the airproof cover 216 also can be attached to one side of the waterproof air-permeable cover 214 away from the airproof region R2 for covering the sewing trace T1. Thus, the peripheral part of the waterproof air-permeable cover can be disposed between the airproof cover and the airproof region R2. Certainly, this design also can avoid medical infections pass through from air mattress system.

In this embodiment, the waterproof air-permeable cover 214 of each air cell 210 comprises an inner fabric layer, a waterproof air-permeable membrane and an outer fabric layer, which are not shown in the figures. The waterproof air-permeable membrane is disposed between the inner fabric layer and the outer fabric layer. A part of the outer fabric layer is exposed to the outside by the opening 212a. The inner fabric layer is a mesh fabric. The outer fabric layer is made from Nylon. The waterproof air-permeable membrane is made from Teflon. In another embodiment, the inner fabric layer of the waterproof air-permeable cover is dispensable.

The air mattress system according to each embodiment of the present invention has advantages described below or another advantage. In each embodiment of the present invention, each of the air cells of the air mattress system has the waterproof air-permeable cover. Accordingly, in the situation under which a patient unfit to turn the body is confined to the air mattress system of each embodiment of the present invention for a long duration, gas exhausted from the waterproof air-permeable cover of each air cell can take moisture away from the place between the patient and the corresponding air cell and make the patient's body surface temperature decrease effectively such that the patient feels physically comfortable and the incidence rate of bedsores to the patient can be reduced effectively. Furthermore, since each of the air cells has the belt-shaped opening, the gas exhausted from the waterproof air-permeable cover, disposed at the belt-shaped opening, of each air cell can be distributed uniformly in the direction extending along the belt-shaped opening such that the patient feels more physically comfortable and the incidence rate of bedsores to the patient can be reduced more effectively. In addition, in one of the embodiments of the present invention, since each of the air cells further comprises the airproof cover attached to the sewing trace to cover it, the body fluid of the patient using the air mattress system is prevented from seeping into the air cells in order to protect the next patient using the air mattress system against infections.

Importantly, based on the design of air-permeable region and airproof region (supporting portion) on the upper surface of each air cell, the present invention can provides a efficient supporting force when air loss process or gas exhausted process is implemented. In addition, the connecting design between a plurality of the air cells in the present invention can provides a preferred structural reliability for supporting patients.

The foregoing detailed description of the embodiments is used to further dearly describe the features and spirit of the present invention. The foregoing description for each embodiment is not intended to limit the scope of the present invention. All kinds of modifications made to the foregoing embodiments and equivalent arrangements should fall within the protected scope of the present invention. Hence, the scope of the present invention should be explained most widely according to the claims described thereafter in connection with the detailed description, and should cover all the possibly equivalent variations and equivalent arrangements.

What is claimed is:

1. An air cell, comprising:
a strip body, including an air hole, a upper surface, and a side surface integrated with the upper surface, the upper surface is constituted by a air-permeable region and a airproof region, the side surface and the airproof region are made of airproof material, and the air-permeable region is constituted by a opening; and
a waterproof air-permeable cover, disposed at the strip body and covers the opening,
wherein, when the air cell is in a use state due to air inflation through the air hole, part of gas in the strip body flows out of the air cell through the waterproof air-permeable cover;
wherein, environmental moisture is prevented from entering the air cell by the waterproof air-permeable cover;
wherein, the area of the air-permeable region is smaller than the area of the airproof region.

2. The air cell of claim 1, wherein the opening is a belt-shaped opening, a peripheral part of the waterproof air-permeable cover is disposed inside the strip body via the opening and attached to bottom portion of the airproof region.

3. The air cell of claim 2, wherein the peripheral part of the waterproof air-permeable cover is sewed to bottom portion of the airproof region such that a sewing trace is formed.

4. The air cell of claim 3, further comprising an airproof cover attached to and covering the sewing trace, and a part of the airproof region is disposed between the waterproof air-permeable cover and the airproof cover.

5. The air cell of claim 4, wherein the airproof cover is disposed at the sewing trace by means of high frequency laminate.

6. The air cell of claim 1, wherein the airproof region is a supporting portion which surrounds the air-permeable region for providing supporting force.

7. The air cell of claim 1, wherein the area of the air-permeable region is 5-15% area of the upper surface.

8. An air mattress, suitable for communicating with a air pump, comprising:
a plurality of the air cells, wherein each of the air cell comprising:
a strip body, including an air hole, a upper surface, and a side surface integrated with the upper surface, the upper surface is constituted by a air-permeable region and a airproof region, the side surface and the airproof region are made of airproof material, and the air-permeable region is constituted by a opening; and
a waterproof air-permeable cover, disposed at the strip body and covers the opening,
wherein, when the air cell is in a use state due to air inflation through the air hole, part of gas in the strip body flows out of the air cell through the waterproof air-permeable cover;
wherein, environmental moisture is prevented from entering the air cell by the waterproof air-permeable cover;
wherein, the area of the air-permeable region is smaller than the area of the airproof region;
wherein, the air pump is communicated to the air cells and adapted to inflate the air cells through the air holes;
wherein, each of the air cells further has a long edge and a short edge, and the air cells are combined through the long edge of each air cell.

9. The air mattress of claim 8, wherein the opening is a belt-shaped opening, a peripheral part of the waterproof air-permeable cover is disposed inside the strip body via the opening and attached to bottom portion of the airproof region.

10. The air mattress of claim 9, wherein the peripheral part of the waterproof air-permeable cover is sewed to bottom portion of the airproof region such that a sewing trace is formed.

11. The air mattress of claim 10, wherein each of the air cells further comprises an airproof cover attached to and covering the sewing trace, and a part of the airproof region is disposed between the waterproof air-permeable cover and the airproof cover.

12. The air mattress of claim 11, wherein the airproof cover is disposed at the sewing trace by means of high frequency laminate.

13. The air mattress of claim 8, wherein the airproof region is a supporting portion which surrounds the air-permeable region for providing supporting force.

14. The air mattress of claim 8, wherein the area of the air-permeable region is 5-15% area of the upper surface.

15. An air mattress system, comprising:
a plurality of the air cells, wherein each of the air cell comprising:
a strip body, including an air hole, a upper surface, and a side surface integrated with the upper surface, the upper surface is constituted by a air-permeable region and a airproof region, the side surface and the airproof region are made of airproof material, and the air-permeable region is constituted by a opening faces upward;
a waterproof air-permeable cover, disposed at the strip body and covers the opening; and
an air pump, communicated to the air cells and adapted to inflate the air cells through the air holes;
wherein, when the air cell is in a use state due to air inflation through the air hole, part of gas in each strip body of the air cell flows out of the air cells through the waterproof air-permeable cover;
wherein, environmental moisture is prevented from entering the air cell by the waterproof air-permeable cover;
wherein, the area of the air-permeable region is smaller than the area of the airproof region;
wherein, each of the air cells further has a long edge and a short edge, and the air cells are combined through the long edge of each air cell.

16. The air mattress system of claim 15, wherein the opening is a belt-shaped opening, a peripheral part of the waterproof air-permeable cover is disposed inside the strip body via the opening and attached to bottom portion of the airproof region.

17. The air mattress system of claim 16, wherein the peripheral part of the waterproof air-permeable cover of each air cell is sewed to bottom portion of the corresponding airproof region such that a sewing trace of each air cell is formed.

18. The air mattress system of claim 17, wherein each of the air cells further comprises an airproof cover attached to and covering the corresponding sewing trace by means of high frequency laminate, and a part of the airproof region of each air cell is disposed between the corresponding waterproof air-permeable cover and the corresponding airproof cover.

19. The air mattress system of claim 15, wherein the airproof region is a supporting portion which surrounds the air-permeable region for providing supporting force.

20. The air mattress system of claim 15, wherein the area of the air-permeable region is 5-15% area of the upper surface.
